(19) United States
(12) Patent Application Publication
(10) Pub. No.: US 2025/0131713 A1
(43) Pub. Date: Apr. 24, 2025

(54) METHOD FOR EXTRACTING AND CALCULATING GULLY AREA IN LOESS PLATEAU

(71) Applicant: Institute of Land Engineering and Technology, Shaanxi Provincial Land Engineering Construction, Xi'an (CN)

(72) Inventors: Jichang HAN, Xi'an (CN); Yang ZHANG, Xi'an (CN); Zenghui SUN, Xi'an (CN); Tingyu ZHANG, Xi'an (CN); Yanan LI, Xi'an (CN); Liheng XIA, Xi'an (CN); Jianglong SHEN, Xi'an (CN); Na LEI, Xi'an (CN); Panpan ZHANG, Xi'an (CN); Jing ZHANG, Xi'an (CN); Yufei XIONG, Xi'an (CN)

(73) Assignee: Institute of Land Engineering and Technology, Shaanxi Provincial Land Engineering Construction, Xi'an (CN)

(21) Appl. No.: 19/006,358

(22) Filed: Dec. 31, 2024

Related U.S. Application Data
(63) Continuation-in-part of application No. PCT/CN2023/130072, filed on Nov. 7, 2023.

(30) Foreign Application Priority Data
Nov. 10, 2022 (CN) 202211406388.6

(51) Int. Cl. G06V 20/10; G06T 7/60; G06V 10/25; G06V 20/13

(52) U.S. Cl. CPC G06V 20/182; G06T 7/60; G06V 10/25; G06V 20/13

(57) ABSTRACT

This application discloses a method for extracting and calculating the gully area of loess plateau, which includes: obtaining remote sensing images of sample regions by a remote sensing satellite, analyzing the remote sensing images to obtain a digital elevation model, determine the primary gully area and secondary gully area of the sample region, determining a reference ratio, obtaining the primary gully area and the research region area of the census region, determining the secondary gully area of the census region, storing the secondary gully area of the census region in the storage unit, determining the secondary gully area of the research region. This method can accurately extract a large scale gully area of the loess plateau without a lot of manual labor.

### CROSS-REFERENCE TO RELATED APPLICATION

This application is a continuation-in-part of International Application No. PCT/CN2023/130072, filed on Nov. 7, 2023, which claims priority to Chinese Patent Application No. 202211406388.6 titled “LOESS PLATEAU RAVINE AREA EXTRACTION AND CALCULATION METHOD” filed on Nov. 10, 2022, the entire contents of which are incorporated herein by reference.

### TECHNICAL FIELD

This disclosure relates to the technical field of land resources census, in particular to a method for extracting and calculating the gully area in loess plateau.

### BACKGROUND

The loess plateau is a typical loess landform, which can be divided into gully and inter-gully according to its shape and location. Gully is also called valley or ravine, which is composed of gully slope and gully bottom. Gully slope refers to the part below the trench edge line of the gully and above the foot line of gully bottom slope, and the gully bottom is the part below the foot line of gully bottom slope.

At present, national and local census agencies can census the gully area of the loess plateau within a certain range, but the object of the census called the primary gully is mainly the gully area with the upper edge of the slope as the trench edge line. However, in actual research, the object of the census may need to be the gully area called the secondary gully with the foot line of the gully as the trench edge line. The area of the primary gully is much larger than the area of the secondary gully. Although a small region area of the secondary gully can be extracted by manual interpretation. The workload of manual interpretation will be huge when the research region is large, and the accuracy cannot be guaranteed. Therefore, how to accurately extract the secondary gully area in a large region is an important topic in the field of land resources investigation and extraction.

### SUMMARY

This disclosure embodiment provides a method for extracting and calculating the gully area in the loess plateau to solve the problem that there is no method for accurately determining the area of a secondary gully in the prior art.

This disclosure embodiment provides a method for extracting and calculating gully area in the loess plateau, including: obtaining remote sensing images of multiple sample regions by a remote sensing satellite, and storing the remote sensing images in a storage unit; retrieving and analyzing the remote sensing images stored in the storage unit by a processor, to obtain a digital elevation model (DEM); storing the digital elevation model in the storage unit; acquiring the digital elevation model stored in the storage unit to determine the primary gully area and secondary gully area of the sample region by the processor; storing the primary gully area and secondary gully area in the storage unit; acquiring the primary gully area and secondary gully area stored in the storage unit to determine a reference ratio, then storing the reference ratio in the storage unit by the processor; obtaining the primary gully area and the research region area of the census region by a data input device; storing the primary gully area and research region area of the census region in the storage unit; obtaining the reference ratio and the primary gully area of the census region stored in the storage unit by the processor to determine the secondary gully area of the census region, and storing the secondary gully area of the census region in the storage unit; extracting the secondary gully area and the research area of the census region stored in the storage unit by the processor to determine the secondary gully area of the research region, and storing the secondary gully area of the research region in the storage unit; wherein when determining the reference ratio according to the primary gully area and secondary gully area, the processor acquires the primary gully area and secondary gully area stored in the storage unit, takes the quotient of the secondary gully area and primary gully area of each sample region as the sample ratio, determines the average value of multiple sample ratios, and obtains the reference ratio. After obtaining the reference ratio in this disclosure, the method further includes: determining the length-width ratio of the gully in each sample region and the corresponding reference ratio; performing clustering according to the reference ratio of the length-width ratio; and revising the reference ratio according to the clustering result.

The method for extracting and calculating of the gully area in the loess plateau in present disclosure has the following beneficial effects:

By using remote sensing satellite, storage unit and processor, a method to accurately extract the gully area of the loess plateau in a large range of research regions is completed, which does not require a lot of manual labor, and provides accurate and reliable data for the study of the loess plateau.

### ILLUSTRATED DESCRIPTION

In order to more clearly explain the technical scheme in the embodiments of the present disclosure or the prior art, the following is a brief introduction of the drawings required to be used in the description of the embodiments or the prior art. Obviously, the drawings described below are only some embodiments of the present disclosure. Other drawings can also be obtained from these drawings.

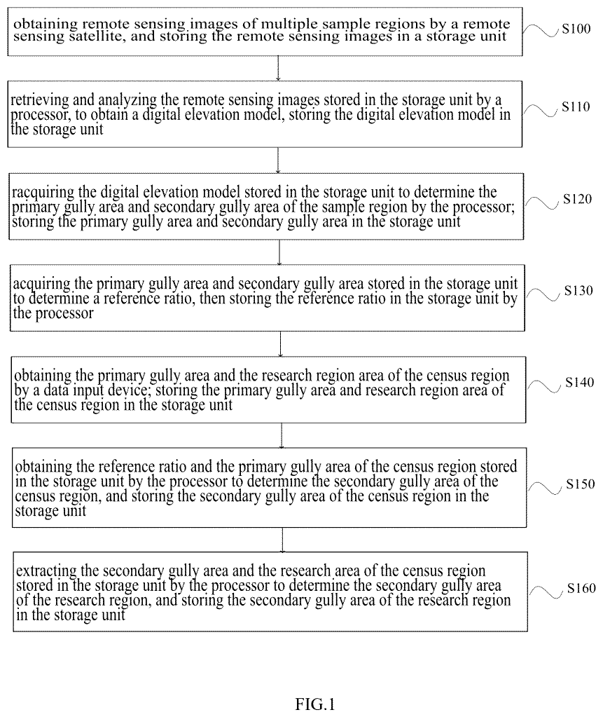

FIG. 1 shows a flow chart of method for extracting and calculating the gully area in the loess plateau according to the embodiment of this disclosure;

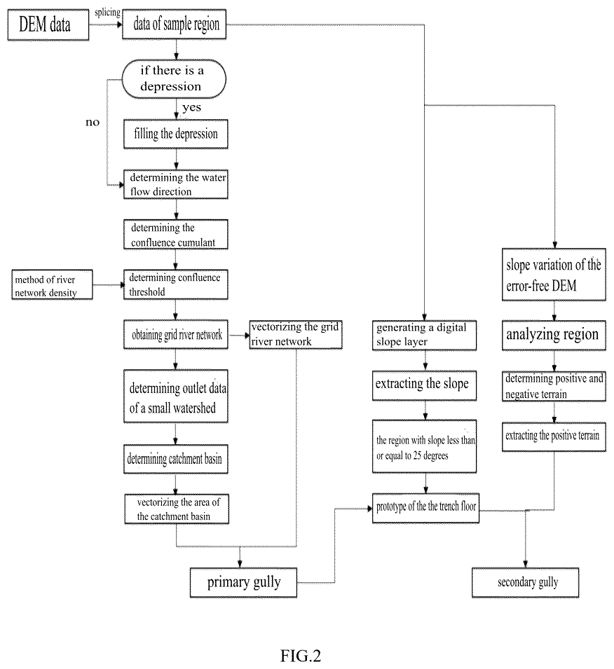

FIG. 2 shows a flow chart of the method for extracting the area of primary gully and secondary gully in the sample according to the embodiment of this disclosure;

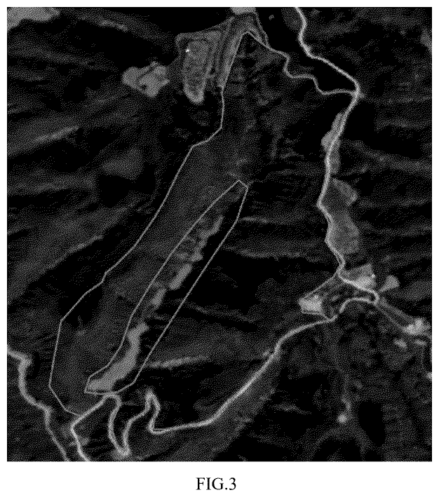

FIG. 3 shows a schematic diagram of extraction of primary gully and secondary gully according to the embodiment of this disclosure;

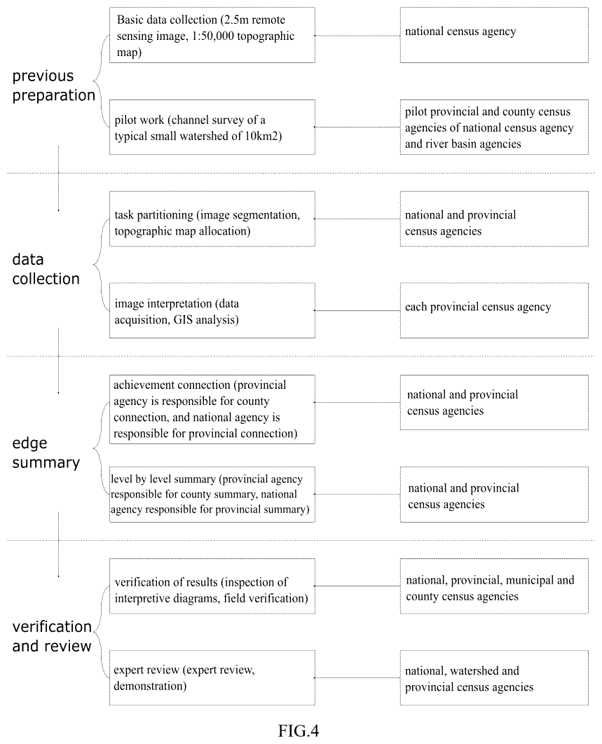

FIG. 4 shows a schematic diagram of the census process of the Soil and Water Conservation Office according to the embodiment of this disclosure;

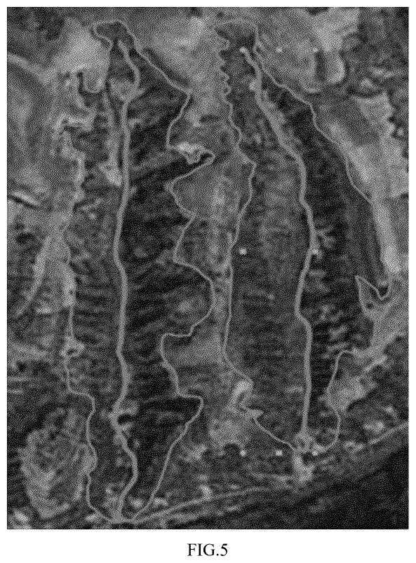

FIG. 5 shows a schematic diagram of the trench area drawn by the Soil and Water Conservation Office according to the embodiment of this disclosure.

### DETAILED DESCRIPTION

The technical scheme in the embodiments of this disclosure will be clearly and completely described in combination with the drawings attached to the embodiments of this disclosure. Obviously, the embodiments described are only part of the embodiments of this disclosure, but not all embodiments. Based on the embodiments in this disclosure, all other embodiments obtained by ordinary skilled persons in the field without creative labor are within the scope of protection in this disclosure.

FIG. 1 shows a flow chart of method for extracting and calculating the gully area in the loess plateau according to the embodiment of this disclosure. This disclosure embodiment provides a method for extracting and calculating gully area in the loess plateau, including:
S100, obtaining remote sensing images of multiple sample regions by a remote sensing satellite, and storing the remote sensing images in a storage unit.

For example, the remote sensing satellite will fly over the sample regions when it is running in the earth orbit. At this time, the remote sensing images of the sample region can be collected by the remote sensing satellite and be stored in a temporary storage media, such as hard disk, memory card, CD, etc. Then the remote sensing images in the temporary storage media can be downloaded by the monitoring station on the ground to the storage unit of a computer, such as hard disk, memory card, CD, etc, to preserve the remote sensing images for a long time.
S110, retrieving and analyzing the remote sensing images stored in the storage unit by a processor, to obtain a digital elevation model (DEM), and then storing the digital elevation model in the storage unit.

For example, a computer is set up in a monitoring station on the ground, and the processor of the computer will retrieve the data in the storage unit for analysis and further storage.

S110 specifically includes: retrieving and analyzing the remote sensing images stored in the storage unit by processor, to obtain original digital elevation model (DEM), executing coordinate conversion and projection conversion to the original digital elevation model, and splicing the converted original digital elevation model to obtain the digital elevation model of the sample region. Specifically, the original digital elevation model can adopt the digital elevation model obtained from the original acquisition of 30 m, and also can adopt the remote sensing image with 2.5 m resolution as an auxiliary data. In practical disclosure, the combination of software automatic analysis and manual post-processing can be used to extract the gully bottom line and catchment range line by combining the original digital elevation model and the remote sensing image, to obtain a final accuracy rate more than 90%. After the theoretical calculation is completed, field investigation is also needed to verify the gully length, the gully width and the area of the sample region.
S120, acquiring the digital elevation model stored in the storage unit to determine the primary gully area and secondary gully area of the sample region, then storing the primary gully area and secondary gully area in the storage unit by the processor.

Illustratively, as shown in FIG. 2, the S120 specifically includes: acquiring the digital elevation model stored in the storage unit, determining the flow direction according to the digital elevation model of the sample region, and then determining the confluence cumulant; determining the corresponding confluence threshold according to the river network density and the confluence cumulant of the sample region; griding the sample region according to the confluence threshold, to obtain grid river network; determining outlet data of a small watershed according to the grid river network; determining catchment basin according to the outlet data of the small watershed, vectorizing the area of the catchment basin, vectorizing the grid river network, determining the primary gully of the sample region according to the vectorized grid river network and the vectorized catchment basin; determining the positive and negative terrain distribution of the sample region according to the original digital elevation model and the digital elevation model of the sample region; extracting positive terrain grid region in the positive and negative terrain distribution of the sample region, selecting the primary gully in the sample region to obtain a prototype of the trench floor, and merging the positive terrain grid region and the prototype of the trench floor to obtain the secondary gully in the sample region to determine the areas of the primary gully region and the secondary gully region.

In the embodiments of this disclosure, before determining the water flow direction of the sample region according to the digital elevation model of the sample region, the method further includes: determining whether there is a depression in the digital elevation model of the sample region, if there is a depression, filling the depression by the processor and then determining the water flow direction of the sample region according to the digital elevation model of the sample region, if there is no depression in the digital elevation model, directly determining the flow direction of the sample region.

The process of “selecting the primary gully in the sample region to obtain the prototype of the trench floor by the processor” includes: generating a digital slope layer corresponding to the digital elevation model of the sample region, extracting the slope in the digital slope layer, and defining the region with slope less than or equal to a slope threshold as the trench floor to form the prototype of the trench floor.

In embodiments of this disclosure, the above slope threshold is 25 degrees. Moreover, the slope variation of the error-free digital elevation model can be determined according to the digital elevation model of the sample region, and then the positive and negative terrain distribution of the sample region can be determined by rasterized subtracting slope variation of the original digital elevation model and the error-free digital elevation model. When extracting the positive terrain grid region in the positive and negative terrain distribution of the sample region, due to the complex terrain of the research region, the directly extracted positive terrain has local grid discontinuous; in order to minimize the influence of the lip line of empty leakage region of the positive terrain grid on the judgment of the trench floor region, so as to obtain the trench floor that is consistent with the real gully, this disclosure obtain prototype of the trench floor conforming to the distribution characteristics by choosing and analyzing the extracted primary gully and slope. After determining the prototype of the trench floor, it is merged with the directly extracted positive terrain grid region, that is, the trench floor grid region that meets the slope requirements and belongs to the relatively complete positive terrain region. Complete trench floor surface region can be obtained by vectorizing the merged grid, to facilitate the calculation of the area.

After determining the primary gully and secondary gully of the sample region, the processor processes the data, and then the operator further selects the processed data through data input devices such as keyboard and mouse. In this way, the shape of the primary gully and secondary gully is obtained, the length and width of the primary gully and secondary gully are measured, and then the linear data layer is topologically formed into a plane, to obtain the area of the gully.
S130: acquiring the primary gully area and secondary gully area stored in the storage unit to determine a reference ratio, then storing the reference ratio in the storage unit by the processor.

For example, S130 specifically includes: when determining the reference ratio according to the primary gully area and secondary gully area, the processor acquires the primary gully area and secondary gully area stored in the storage unit, takes the quotient of the secondary gully area and primary gully area of each sample region as the sample ratio, determines the average value of multiple sample ratios, and obtains the reference ratio.

In the embodiments of this disclosure, the processor selects 300 pairs of gullys as the sample region data, and obtains the data of gully area, gully length and gully width of the gully samples in the sample region, so as to establish the relationship model between geomorphic type (gully length and gully width) and gully area. For example:
(1) The processor selects a certain number of gully samples, and firstly draws the range of the primary gully with upper edge line of the slope, which is called A. Within this range, the range of the secondary gully is drawn according the slope foot line used as the trench edge line of the gully, which is called B. As shown in FIG. 3, there are two closed regions in FIG. 3. The closed region with a larger area is the primary gully, while the closed region with a smaller area is located inside the primary gully and is the secondary gully.
(2) The processor calculates the areas of A and B respectively, denoted as X and Y.
(3) The processor calculates the reference ratio Y/X.

Through the analysis of the sample region by the processor, the primary gully area in multiple gully samples can be obtained: X1, X2, X3 . . . . Sample ratios are defined as: S1=Y1/X1, S2=Y2/X2, S3=Y3/X3 . . . , the average of the sample ratios can be used as the reference ratio: S=(S1+S2+S3+ . . . +Sn)/n, where n is the number of samples.

In some embodiments of this disclosure, although it is simple to determine the reference sample by means of average value, the difference between different samples is ignored. Therefore, after obtaining the reference ratio in this disclosure, the processor also determines the length-width ratio of the gully in each sample region and the corresponding reference ratio, performs clustering according to the reference ratio of the length-width ratio, and revises the reference ratio according to the clustering result.

Specifically, when the processor revises the reference ratio according to the clustering result, it establishes the corresponding correction function in the form of the piecewise function, and uses the correction function to correct the reference ratio.

In this disclosure, the processor uses the gully aspect ratio data to perform cluster analysis on the sample proportions corresponding to 300 groups of samples, and forms a correction function in the form of a piecewise function determined by multiple correction coefficients, which is as follows:

$$S = \{ \begin{matrix}S 1 * 0.6 \\ S 2 * 0.3 \\ S 3 * 0.1\end{matrix}$$

It should be understood that the above correction function containing three correction coefficients is only an example, and in practical applications, the processor can also set greater number and more complex expression of the correction function according to the actual situation and needs.
S140, obtaining the primary gully area and the research region area of the census region by a data input device, and storing the primary gully area and research region area of the census region in the storage unit.

For example, as shown in FIG. 4, the census region is erosion gully with gully length (main gully length) over 500 m and catchment area no larger than 50 km2. The census range covers highland gully region and hilly gully region of the loess plateau, covering 33 cities and 182 counties (cities and districts) in 7 provinces (autonomous regions) of Qinghai, Gansu, Ningxia, Inner Mongolia, Shaanxi, Shanxi and Henan with an area of 248,000 km2. During the census, 2.5 m resolution remote sensing image and 1:50,000 terrain map (DLG) were used as the main information sources. The processor used GIS software installed in the storage unit and cooperated with operators through data input devices such as keyboard and mouse to interpret and extract the length, area and vertical gradient of the erosion gully, as well as its geospatial location, to statistically analysis the number, characteristics and distribution of erosion gullys on the loess plateau. The gully area drawn by the remote sensing image with 2.5 m resolution based on the census results is shown in FIG. 5. The results of the Soil and Water Conservation Census Office show that the total area of erosion gullies in the loess plateau is 187,200 km².
S150: obtaining the reference ratio and the primary gully area of the census region stored in the storage unit by the processor to determine the secondary gully area of the census region, and storing the secondary gully area of the census region in the storage unit.

For example, the census results of the Soil and Water Conservation Census Office show that within 248,000 km2, the area of the primary gully is 187,200 km2, that is, the proportion of X in the overall area is P=75.48%, then the processor can determine the area of the secondary gully in the census region, that is, Y can be expressed as 18.72*S.
S160, extracting the secondary gully area and the research area of the census region stored in the storage unit by the processor to determine the secondary gully area of the research region, and storing the secondary gully area of the research region in the storage unit.

For example, the area of the census region is 248,000 km2, which cannot meet the needs of the research, so the processor set the research area as 640,000 km2 in this disclosure. However, in the above steps, the processor only determines the secondary gully area within 240,000 km2 of the loess plateau, while the area of the census region accounted for 38.75% of the total area of the loess plateau, that is, the research area in this disclosure. The processor could deduce that the secondary gully area within 640,000 km2 of the loess plateau was Y/38.75%.

Although the preferred embodiments of this disclosure have been described, those embodiments may be subject to additional changes and modifications once the basic creative concepts are known to those skilled in the art. Accordingly, the attached claims are intended to be construed to include preferred embodiments and all changes and modifications falling within the scope of this disclosure.

Obviously, persons skilled in the art may make various alterations and variations to this disclosure without deviating from the spirit and scope of this disclosure. Thus, to the extent that these modifications and variations of this disclosure fall within the scope of the claims of this disclosure and their equivalents, this disclosure is also intended to include such modifications and variations.

What is claimed is:

1. A method for extracting and calculating gully area on loess plateau, comprising:
obtaining remote sensing images of multiple sample regions by a remote sensing satellite, and storing the remote sensing images in a storage unit;
retrieving and analyzing the remote sensing images stored in the storage unit by a processor, to obtain a digital elevation model (DEM);
storing the digital elevation model in the storage unit;
acquiring the digital elevation model stored in the storage unit to determine the primary gully area and secondary gully area of the sample region by the processor;
storing the primary gully area and secondary gully area in the storage unit;
acquiring the primary gully area and secondary gully area stored in the storage unit to determine a reference ratio, then storing the reference ratio in the storage unit by the processor;
obtaining the primary gully area and the research region area of the census region by a data input device;
storing the primary gully area and research region area of the census region in the storage unit;
obtaining the reference ratio and the primary gully area of the census region stored in the storage unit by the processor to determine the secondary gully area of the census region, and storing the secondary gully area of the census region in the storage unit;
extracting the secondary gully area and the research area of the census region stored in the storage unit by the processor to determine the secondary gully area of the research region, and storing the secondary gully area of the research region in the storage unit;
wherein when determining the reference ratio according to the primary gully area and secondary gully area, the processor acquires the primary gully area and secondary gully area stored in the storage unit, takes the quotient of the secondary gully area and primary gully area of each sample region as the sample ratio, determines the average value of multiple sample ratios, and obtains the reference ratio;
after obtaining the reference ratio in this disclosure, further comprises:
determining the length-width ratio of the gully in each sample region and the corresponding reference ratio;
performing clustering according to the reference ratio of the length-width ratio; and
revising the reference ratio according to the clustering result.

2. The method of claim 1, wherein the process “retrieving and analyzing the remote sensing images stored in the storage unit by a processor, to obtain a digital elevation model” comprises:
retrieving and analyzing the remote sensing images stored in the storage unit by processor, to obtain original digital elevation model;
executing coordinate conversion and projection conversion to the original digital elevation model; and
splicing the converted original digital elevation model to obtain the digital elevation model of the sample region.

3. The method of claim 1, wherein the process “acquiring the digital elevation model stored in the storage unit to determine the primary gully area and secondary gully area of the sample region by the processor” comprises:
acquiring the digital elevation model stored in the storage unit to determine the flow direction according to the digital elevation model of the sample region;
determining the corresponding confluence threshold according to the river network density and the confluence cumulant of the sample region;
griding the sample region according to the confluence threshold, to obtain grid river network;
determining outlet data of small watershed according to the grid river network;
determining catchment basin according to the outlet data of the small watershed, and vectorizing the area of the catchment basin and the grid river network;
determining the primary gully of the sample region according to the vectorized grid river network and the vectorized catchment basin;
determining the positive and negative terrain distribution of the sample region according to the original digital elevation model and the digital elevation model of the sample region;
extracting positive terrain grid region in the positive and negative terrain distribution of the sample region;
selecting the primary gully in the sample region to obtain a prototype of the trench floor;
merging the positive terrain grid region and the prototype to obtain the secondary gully in the sample region to determine the area of the primary gully region and the area of the secondary gully region.

4. The method of claim 3, wherein before the process “determining the water flow direction of the sample region according to the digital elevation model of the sample region”, the method further comprises:
determining whether there is a depression in the digital elevation model of the sample region, if there is a depression, filling the depression by the processor and then determining the water flow direction of the sample region according to the digital elevation model of the sample region.

5. The method of claim 3, wherein the process “selecting the primary gully in the sample region to obtain a prototype of the trench floor” comprises:
generating a digital slope layer corresponding to the digital elevation model of the sample region;
extracting the slope in the digital slope layer; and
defining the region with slope less than or equal to a slope threshold as the the trench floor to form the prototype of the trench floor.

6. The method of claim 1, wherein the process “revising the reference ratio according to the clustering result” comprises:
establishing the corresponding correction function in the form of the piecewise function according to the clustering result; and
correcting the reference ratio according to the correction function.
